(19) United States
(12) Patent Application Publication
(10) Pub. No.: US 2020/0043016 A1
(43) Pub. Date: Feb. 6, 2020

(54) NETWORK NODE FOR PROCESSING MEASUREMENT DATA

(71) Applicant: Siemens Aktiengesellschaft, München (DE)

(72) Inventor: Bernd Nicklis, Landau (DE)

(21) Appl. No.: 16/531,792

(22) Filed: Aug. 5, 2019

(30) Foreign Application Priority Data
Aug. 6, 2018 (EP) 18187536.0

(51) Int. Cl. G06Q 30/00; H04L 9/32

(52) U.S. Cl. CPC G06Q 30/0185; H04L 9/3242

(57) ABSTRACT

Provided is a node of a network according to one embodiment. Here, the node includes a measuring device configured to capture measurement data that map at least one physical variable. The node further includes a receiver device configured to receive a blockchain. The node further includes a generation device configured to generate a data block for the blockchain on the basis of the measurement data and the blockchain. The node further includes an output device configured for separate output (i) of the data block for validation by a further node and (ii) of the measurement data. A method for processing measurement data and a method for monitoring processing of an industrial product by a multiplicity of measurement nodes of a network and by means of a blockchain according to further embodiments is also provided.

### CROSS-REFERENCE TO RELATED APPLICATIONS

This application claims priority to EP Application No.18187536.0, having a filing date of Aug. 6, 2018, the entire contents of which are hereby incorporated by reference.

### FIELD OF TECHNOLOGY

A node of a network is disclosed according to one embodiment. A method for processing measurement data is disclosed according to a further embodiment. A method for monitoring processing of an industrial product by a multiplicity of measurement nodes of a network and by means of a blockchain is disclosed according to a further embodiment.

### BACKGROUND

The increased trade of commodities such as crude oil and natural gas, for example, in a globalizing world is accompanied by an expansion of systems that span countries and continents and facilitate the conveyance of these commodities. Here, the involved trade partners arrange for a transfer of such commodities by means of the transport system, for the purposes of which the commodity provider should usually obtain monetary compensation from the commodity taker.

The extent of such monetary compensation may depend on various factors, which may comprise, for example, an amount, a quality or a delivery time of the commodities. Such monetary rewards dependent on these factors may be recorded in a contractual agreement, and so it is desirable for the confident implementation of the commercial relationship for both contracting parties to receive unfalsified information about the commodity supply that has taken place during the entire supply period.

Particularly in the case of permanent supply relationships in the energy sector, for example when transporting crude oil and natural gas, large amounts of data have to be captured over a relatively long period of time, the forgery-proof provision of which to the relevant trade partners currently only being realizable with huge storage space requirements. Accordingly, there is a need for measures on the basis of which measurement data in respect of such commodity transports can be indicated as unfalsified to one trade partner.

Furthermore, at this moment in time, blockchain technology or “distributed ledgers” is currently an intensely discussed technology for improved security against manipulation; in particular, this technology can be realized as a distributed database system. New application options in addition to applications for decentralized payment systems (e.g., bit coin) are developed by the financial industry. In particular, this allows transactions between companies to be realized in a manipulation-protected manner without a broker or clearing house. This facilitates new commercial models without a trusted broker, it reduces the transaction costs and new digital services can be flexibly offered without needing to set up infrastructure and confidential relationships specifically configured to this end. A transaction data record (transaction for short), which is protected by a blockchain, comprises, e.g., program code which may also be referred to as a so-called “smart contract”.

The prior art has disclosed the document U.S. Pat. No. 8,531,247 B2, the document U.S. Pat. No. 8,892,616 B2, the document U.S. Pat. No. 8,300,811 B2, the document U.S. Pat. No. 9,147,088 B2, the document U.S. Pat. No. 9,584,311 B2, the document EP 2976707 B1, the document EP 2 605 445 B1, the document EP 2 870 565 A1, the document EP 2 891 102 A1, the document WO 2017137256 A1, the document EP 2870565 B1, EP 2891266 B1, the document EP 2961091 A1, the document EP 2961093 A1, the document EP 3028140 B1, the document EP 2930610 B1, the document EP 2940620 B1, the document EP 2899714 A1, the document EP 2981926 A0, the document EP 3125492 B1, the document EP17195125, the document EP17211075, the document EP18178316, the document EP18156084, the document EP18151345, the document EP18167702, the document EP18153594, the document EP18162050, the document EP18178498, the document EP18152117, the document EP18150133, the document EP18169145, the document EP17210647, the document EP18150146, the document EP18167486, the document EP18168670, the document EP18162049, the document EP17203819, the document EP18157168, the document EP18169421, the document EP17210253, the document EP17205224, the document EP18169269, the document EP18169254, the document EP17210288, the document EP18153025, the document EP17200614, the document EP18156308, the document EP17201758, the document EP18156511, the document EP18159485, the document EP17203573, the document EP 17175275, the document EP17186826, the document WO 2018069271 A1, the document PCT/EP2017/082508, the document EP17179823, the document WO 2017050348 A1, the document WO 2018068965 A1 and the document U.S. Pat. No. 8,843,761 B2.

### SUMMARY

An aspect relates to providing an apparatus that can ensure the authenticity of measurement data with technical means that are as simple as possible.

An aspect relates to providing a method that ensures unfalsified measurement data with technical means that are as simple as possible.

An aspect relates to providing a method that ensures unfalsified processing of an industrial product.

A node of a network is disclosed according to one embodiment. Here, the node comprises a measuring device configured to capture measurement data that map at least one physical variable. The node further comprises a receiver device configured to receive a blockchain. The node further comprises a generation device configured to generate a data block for the blockchain on the basis of the measurement data and the blockchain. The node further comprises an output device configured for separate output (i) of the data block for validation by a further node and (ii) of the measurement data.

Using such an approach as a basis facilitates the capture at a node of the network of the measurement data that map at least one physical variable and the processing of said measurement data in a way that allows participants of the network, depending on the application, to obtain different information based on the measurement data. To this end, the node of the network provides a separate output of a data block, which is based on the measurement data, and the measurement data themselves. Here, the generation of the data block on the basis of the measurement data allows information from the measurement data to be incorporated herein in a particularly efficiently saved form, with information content of this data block being comparatively high in relation to the complete measurement data, albeit it possibly having a significantly reduced data volume. By way of example, only particularly important information of the measurement data may be included in the data block or the measurement data may be included in the data block, at least in part, in a compressed form. Further, the inclusion of the data block in the existing blockchain is facilitated by the configuration of the data block for validation by another node of the network. On account of the specific encryption technique of the blockchain the information included in the data block, which relates to the measurement data, can be saved in a manner particularly secured against manipulation in the distributed database of the network such that these measurement data are accessible in unfalsified form for the participants of the network at all times.

A method for processing measurement data is disclosed according to a further embodiment. Here, the method includes the steps of a) capturing the measurement data, which map at least one physical variable, b) receiving a blockchain, c) generating a data block for the blockchain on the basis of the measurement data and the blockchain, and d) separately outputting (i) the data block for validation purposes and (ii) the measurement data.

Using such an approach as a basis facilitates a method that is as simple and efficient as possible to be carried out on the basis of the aforementioned apparatus according to embodiments of the invention.

A method for monitoring the processing of an industrial product by a multiplicity of measurement nodes of a network and by means of a blockchain is disclosed according to a further embodiment. Here, the method includes, at each of the measurement nodes of the multiplicity of measurement nodes, a capture of appropriate measurement data, which map the processing of the industrial product to an appropriate measurement modality. Further, the method includes, at each of the measurement node of the multiplicity of measurement nodes, a generation of a corresponding block for the blockchain on the basis of the blockchain and the corresponding measurement data. Further, the method includes a validation of the block generated by a first measurement node of the multiplicity of measurement nodes by a second measurement node of the multiplicity of measurement nodes and/or by a central unit of the network.

On the basis of such an approach, continuous checking and accompaniment during the generation of an industrial product can be brought about in a manner secured against manipulation and with means that are as simple as possible from a technical point of view.

A node within the meaning of embodiments of the invention should be understood to mean an exchange area within a network, which is configured to exchange data within the network. Here, the node can be configured to carry out functions within the network. The network can be configured to provide a distributed database, for example a blockchain-based database. Here, the node can contribute to updating a blockchain of the blockchain-based database, for example by generating and/or outputting a data block or by validating a data block generated by another node in the network. In conjunction with embodiments of the invention, a node and the like can further also be understood to mean, for example, appliances (e.g., field appliances, cellular telephones), computers, smartphones, clients or participants which carry out operations (with) the distributed database system (e.g., a blockchain). By way of example, such nodes can carry out transactions of a distributed database system or the data blocks thereof or can insert or link new data blocks with new transactions into the distributed database system by means of new data blocks. In particular, this validation and/or linking can be carried out by a trusted node (e.g., a mining node) or only by trusted nodes. By way of example, a trusted node is a node that comprises additional security measures (e.g., firewalls, access restrictions to the node or the like) for preventing a manipulation of the node. As an alternative or addition thereto, a trusted node can, for example, store a node checksum (e.g., a digital signature or certificate) in the new data block when linking a new data block with the distributed database system. Using this, it is possible, in particular, to provide evidence specifying that the corresponding data block was inserted by a certain node or evidence specifying its origin. The appliances (e.g., the appropriate appliance) also relate to, for example, appliances of a technical system and/or an industrial installation and/or an automation network and/or manufacturing installation, which, in particular, are also nodes in the distributed database system. Hence, the devices can be, for example, field devices or devices in the Internet of Things which, in particular, are also nodes in the distributed database system. By way of example, nodes can also comprise at least one processor, for example in order to carry out their computer-implemented functionality.

Measurement data within the meaning of embodiments of the invention should be understood to mean information of a system which can be obtained on the basis of a measurement. The measurement data may relate to properties of a transportable substance and/or of an industrial product. By way of example, such a transportable substance may comprise at least one of crude oil, natural gas, water, sewage and chemicals. The properties of the transportable substance may further relate to the quality thereof and/or the amount thereof and can further be correlated with corresponding time intervals or times at which the measurement data were collected. The properties of the transportable substance may further comprise information relating to the composition thereof, the calorific value thereof and the constituents thereof.

A blockchain within the meaning of embodiments of the invention should be understood to mean a continuously extendable chain of data blocks, the linking of which is implemented on the basis of a cryptographic linking method. Here, two data blocks can be linked using a checksum which is characteristic for the data of all preceding data blocks in the blockchain. Here, the checksum can also be referred to as a hash value and the cryptographic link can be implemented on the basis of a so-called proof of stake method or a so-called proof of work method.

A data block within the meaning of embodiments of the invention can be understood to mean, in conjunction with embodiments of the invention, a data block of a blockchain, for example, said blockchain more particularly being realized as a data structure and respectively comprising one or more of the transactions. In one implementation, a data block can be a block of the blockchain, for example. By way of example, a data block can comprise specifications relating to the size (data size in byte) of the data block, a data block header, a transaction counter and one or more transactions. By way of example, the data block header can comprise a version, a linking checksum, a data block checksum, a timestamp, proof of work evidence and a nonce (single value, random value or counter that is used for the proof of work evidence). By way of example, a data block may also relate to only a certain storage range or address range of the overall data which are stored in the blockchain-based database. Here, at least one transaction of the data block can be based on the measurement data. By way of example, the at least one transaction may comprise a checksum of the measurement data.

A validation within the meaning of embodiments of the invention should be understood to mean the authorization to link a data block with an existing blockchain. Here, this authorization can be based on a check of a data block by a node of a network, wherein the check may be based on the ascertainment of a checksum on the basis of the data included in the blockchain.

A measurement modality within the meaning of embodiments of the invention should be understood to mean a manner in which measurement data are obtained by a system to be examined.

According to one embodiment of the node, the data block comprises a checksum of the measurement data.

In this way, a unique map of the measurement data can be generated in the data block, which is configured to be saved in the blockchain, said map being able to indicate the authenticity of the measurement data. Consequently, the authenticity of the measurement data can be checked by way of the validation of the checksum by another node of the network and shared with the node of the network via the blockchain such that a contracting party can easily be informed about this information. Further, in relation to the original data, the checksum has a significantly reduced data volume, and so the storage resources required for the blockchain which continues to get written over time remain manageable.

According to one embodiment of the node, the data block does not comprise the measurement data.

On the one hand, this allows the data volume of the data block provided for the blockchain to be reduced. On the other hand, this can protect the distribution of sensitive data of contracting parties, which were ascertained by the measurement data, from being published in the blockchain-based database.

According to one embodiment of the node, the measuring device is configured for time-sequential capture of the measurement data and for aggregation of the measurement data in conjunction with the generation of the data block.

This allows measurement data to be ascertained continuously by a system. This may be important, in particular, in the case of systems in which a transportable substance is permanently transferred between contracting parties through a transport system and in which said substance should be monitored, for example in the case of natural gas, crude oil or water supplies. The aggregation of these permanently ascertained measurement data can thus be combined in an appropriate data block, in an adequate manner from a size point of view, and can be output to a further node for the purposes of validation for the blockchain. As a result, a publication of the data blocks that are based on the measurement data can be flexibly adapted to the respective requirements of the network participants.

According to one embodiment, the node further comprises a status querying device configured to determine status data that relate to an operational parameter of the measuring device, wherein the data block generated by the generation device is further based on the status data.

This allows states and procedures relating to the measuring device to be indicated in the data block and allows said states and procedures to be output to the further node for the purposes of validation for the blockchain. Such states and procedures of the measuring device may indicate, for example, the presence and time period of servicing works, inspections, manual impairments and manipulations by an unauthorized party and can consequently comprise additional information about the authenticity of the measurement data. This can further improve the security of the measurement data in relation to manipulations.

According to one embodiment of the node, the output device is configured to output the data block to a central node of the network for validation purposes.

This allows the validation and inclusion of measurement data-based data blocks to be controlled by a central authority. This controls a prioritization of the check and the inclusion of data blocks into the blockchain from a multiplicity of different data blocks of various nodes by the central authority in accordance with the requirements of the network participants. This facilitates an improved control of the information distributed in the network by the blockchain or the published information, as a result of which more reliable procedures arise during the regular update of the blockchain.

According to one embodiment of the node, the output device is configured to output the data block to a memory, wherein the memory is a local memory or cloud memory.

This allows the node to output the generated data block to the other node for the purposes of validation for the blockchain at any time. This facilitates an improved flexibility for the data output to the block time, which can meet the requirements of the network participants in an improved manner.

According to one embodiment of the node, the latter further comprises a buffer storing device, which is configured to temporarily store the data block until the transfer by the output device to the memory can be facilitated.

This can ensure the transfer of the data block to the memory even in cases where the data transfer to the memory may be interrupted. This obtains improved saving of the data block.

According to one embodiment of the node, the blockchain comprises a multiplicity of saved blocks, wherein the saved blocks are indicative for further measurement data of further measuring devices of further nodes of the network.

Since the generatable data block is based on the blockchain, this facilitates measurement data of further data blocks to be taken into account when generating the data block. This facilitates an improved comparison and an improved check of the blockchain in the case where measurement data and/or a measuring device of a node have been manipulated. This facilitates an improved security standard when checking for the presence of manipulations in the network.

According to an embodiment of the node, the output device is configured to transfer the data block and the measurement data to different nodes within the network.

This allows the measurement data and the data block based on the measurement data to be shared with different groups of participants within one or more networks. By way of example, this can share the presence of unfalsified measurement data with all participants of a blockchain network by linking the data block with the blockchain, whereas the possibly significantly more sensitive measurement data, which may relate to a supply by a contracting party, are only exchanged between the contracting parties. This can obtain improved protection of sensitive measurement data from unauthorized parties.

According to one embodiment of the node, the receiver device is further configured to receive a further data block from a further node of the network for the purposes of processing further measurement data of a further measuring device and the node further comprises a validation module configured to validate the further data block on the basis of a comparison of a checksum of the further data block with the blockchain and to link the further data block with the blockchain depending on a validation result.

In this way, the node comprising the measuring device is itself able to validate further data blocks, which are based on further measurement data, for linking in the blockchain. This facilitates a decentralized and consequently time-efficient update of the blockchain.

According to one embodiment of the node, the measurement data relate to an amount and/or a quality of a substance that is transportable in a transport system.

This allows features that are characteristic of the quality and/or quantity of the transportable substance and consequently essential for forming the price between the contracting parties or for substantial contract parts being met—for example, the presence of a transportable substance with sufficiently high quality—to be ascertained and to be processed further or immediately output for distribution between the contracting parties or the network participants.

According to an embodiment of the method for processing measurement data, the latter is carried out on a node according to one of the embodiments presented herein.

In this way, the captured measurement data are processed with means that are particularly simple from a technical point of view and in a particularly efficient manner.

According to an embodiment of the method for monitoring the processing, different measurement nodes of the multiplicity of measurement nodes map the processing of the industrial product by different measurement modalities and/or at different times and/or at different positions.

In this way, monitoring the processing of the industrial product can be carried out in a particularly flexible manner.

The aspects relating to the respective embodiment described above and the associated measures disclosed for developing the node also apply to the embodiments and the associated developments of the associated method for processing measurement data and of the method for monitoring the processing of an industrial product.

A checksum within the meaning of embodiments of the invention, for example a data block checksum, a data checksum, a node checksum, a transaction checksum, a linking checksum or the like, can, in conjunction with embodiments of the invention, be understood to mean, for example, a cryptographic checksum or cryptographic hash or hash value, which, in particular, are formed or calculated by means of a cryptographic hash function over a data record and/or data and/or one or more of the transactions and/or a portion of a data block (e.g., the block header of a block of a blockchain or data block header of a data block of the distributed database system or only some of the transactions of a data block). In particular, a checksum can relate to the checksum(s) or hash value(s) of a hash tree (e.g., Merkle tree, PATRICIA tree). Furthermore, this can also be understood to mean, in particular, a digital signature or cryptographic message authentication code. By way of example, the checksum can be used to realize a cryptographic protection/manipulation protection for the transactions and the data records stored therein on different levels of the database system. By way of example, if high security is demanded, the checksums are produced and checked on the transaction level, for example. If less high security is demanded, the checksums are produced and checked on the block level (e.g., over the entire data block or only over part of the data block and/or some of the transactions), for example. As raw data, a checksum to be ascertained can use measurement data that map at least one physical variable.

Status data within the meaning of embodiments of the invention are understood to mean information that may relate to past and/or current and/or future events of a node of a network and the state of a node of a network. Such status data of the node may indicate actions on the node, for example servicing works, manipulations and inspections on the node.

A central node within the meaning of embodiments of the invention should be understood to mean a node of a network that is configured for data exchange with at least two further nodes. Here, the central node may be configured to receive and validate a multiplicity of data blocks for the blockchain. Further, the central node can be configured to inform at least two further nodes of the network about an update of the blockchain. The central node may be embodied as central authority of the network.

In conjunction with embodiments of the invention, a memory and the like can be understood to mean, for example, a volatile memory in the form of random-access memory (RAM) or a permanent memory such as a hard disk drive or a data medium.

In conjunction with embodiments of the invention, comprise, have, include or the like, in particular in relation to data and/or information can be understood to mean a (computer-assisted) storage of appropriate information or an appropriate datum in a data structure/data record (which, e.g., is stored in a memory unit in turn), for example.

In conjunction with embodiments of the invention, provision, in particular in relation to data and/or information, can be understood to mean a computer-assisted provision, for example. By way of example, the provision is implemented by way of an interface (e.g., a database interface, a network interface, an interface to a memory unit). By way of example, appropriate data and/or information can be transferred and/or transmitted and/or recalled and/or received within the scope of provision by way of this interface. In conjunction with embodiments of the invention, provision can also be understood to mean loading or saving, for example a transaction with appropriate data. By way of example, this can be implemented on or by a memory module. By way of example, provision can also be understood to mean a transfer (or a transmission or communication) of corresponding data from one node to another node of the blockchain or of the distributed database system (or the infrastructure thereof).

In conjunction with embodiments of the invention, linking (the) data blocks of the blockchain or the like can be understood, for example, to mean that data blocks each comprise information (e.g., a linking checksum) that refers to another data block or a plurality of other data blocks of the distributed database system, or references the latter.

In conjunction with embodiments of the invention, a transaction can be understood, for example, to mean a smart contract, a data structure or a transaction data record which, in particular, comprises one of the transactions or a plurality of transactions in each case. In conjunction with embodiments of the invention, a transaction can also be understood to mean the data of a transaction of a data block of a blockchain, for example. In particular, a transaction can comprise a program code that realizes a smart contract, for example. By way of example, a transaction in conjunction with embodiments of the invention can also be understood to mean a control transaction and/or a confirmation transaction. Alternatively, a transaction can be, e.g., a data structure that stores data (e.g., the control commands and/or contract data and/or other data such as video data, user data, measurement data, etc.).

The aforementioned and further advantages, features and application possibilities of an embodiment emerge from the following description of exemplary embodiments on the basis of at least partly schematic figures.

### BRIEF DESCRIPTION

Some of the embodiments will be described in detail, with reference to the following figures, wherein like designations denote like members, wherein:

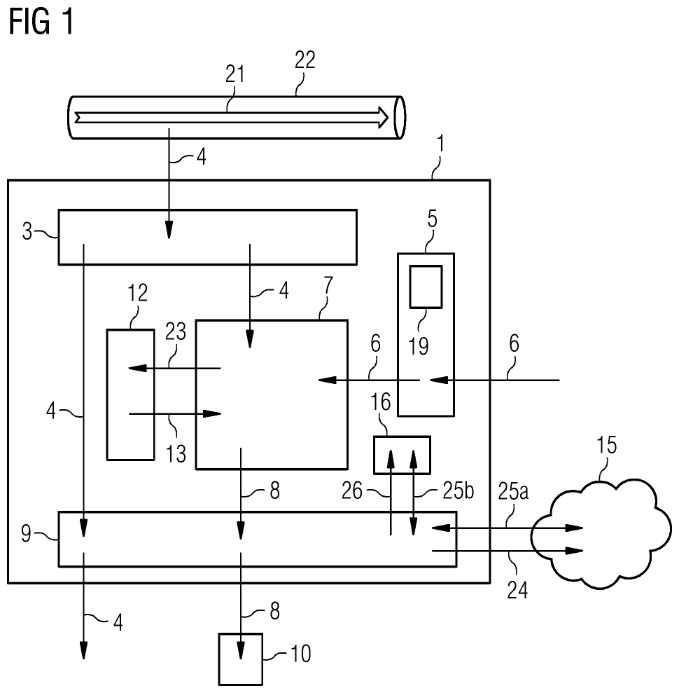

FIG. 1 schematically illustrates a node of a network according to one embodiment, said node being configured to process measurement data;

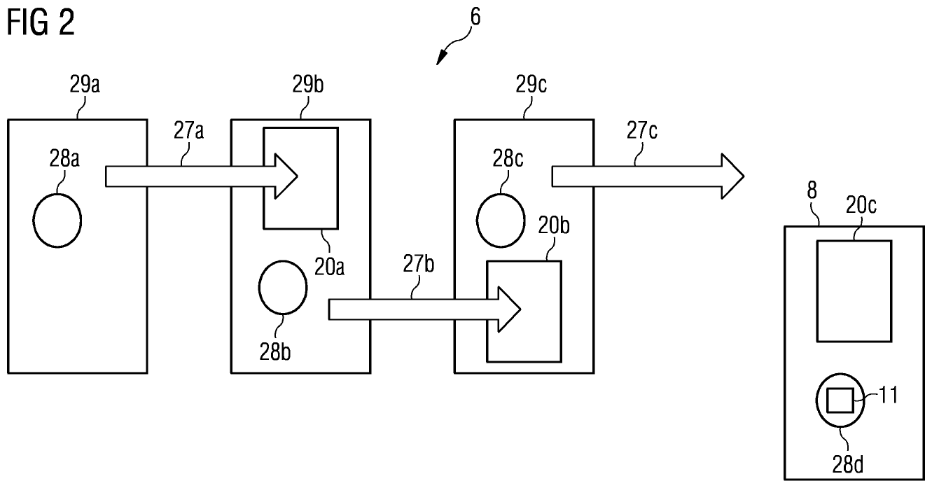

FIG. 2 schematically illustrates a blockchain according to one embodiment, for which a node as disclosed herein can generate a data block;

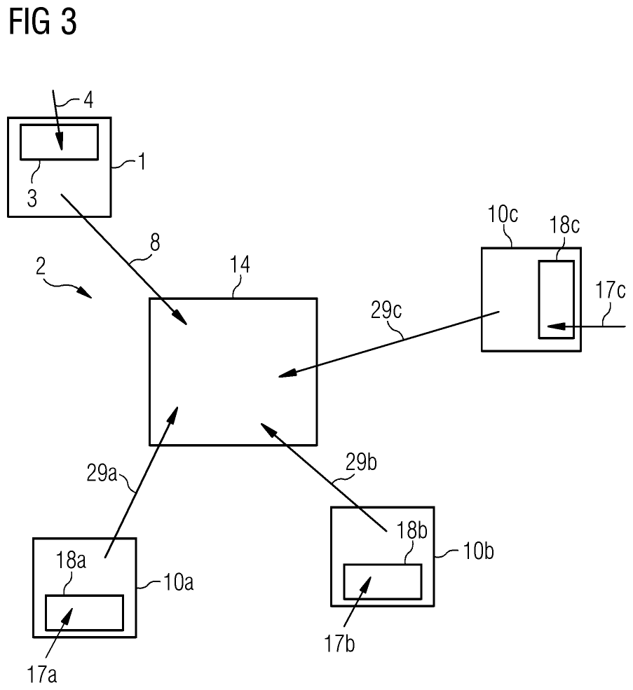

FIG. 3 illustrates a network with a multiplicity of nodes for data exchange according to one embodiment;

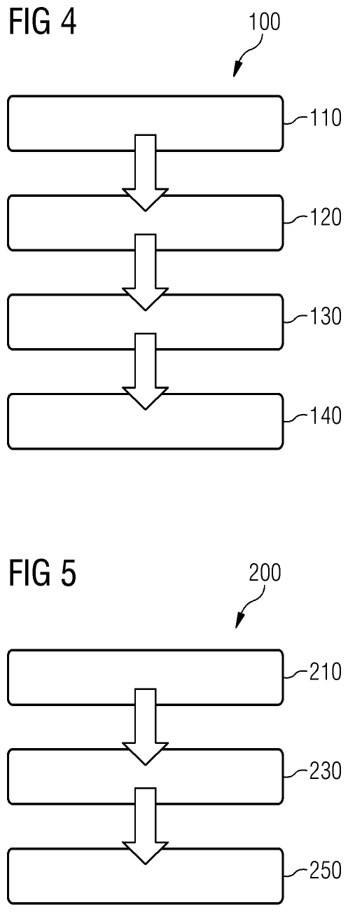

FIG. 4 illustrates a flowchart of a method for processing measurement data according to one embodiment; and

FIG. 5 illustrates a flowchart of a method for monitoring the processing of an industrial product by a multiplicity of nodes of a network and by means of a blockchain according to one embodiment.

### DETAILED DESCRIPTION

Provided nothing else is specified in the following description, the terms “performing”, “calculating”, “computer-assisted”, “calculation”, “determining”, “generating”, “configuring”, “reconstructing” and the like relate to actions and/or processes and/or processing steps that modify data and/or generate data and/or convert the data into different data, wherein the data, in particular, can be presented as physical variables or can be present as such, for example as electrical pulses. In particular, the expression “computer” should be interpreted as broadly as possible in order, in particular, to cover all electronic appliances with data-processing properties. Consequently, computers can be, for example, personal computers, servers, programmable logic controllers (PLC), handheld computer systems, pocket PC appliances, mobile radio appliances and other communication appliances that are able to process data in computer-assisted fashion, processors and other electronic appliances for data processing.

FIG. 1 schematically illustrates a node 1 of a network 2 according to one embodiment, said node being configured to process measurement data 4. Here, the node 1 can be arranged in the surroundings of a transport system 21 which is configured to transport a transportable substance 22. By way of example, at least one of crude oil, natural gas, water, sewage and electric current can be provided as transportable substance 22.

Here, the node according to FIG. 1 may comprise a measuring device 3, which is configured to capture measurement data 4 that map at least one physical variable. Further, the measurement data 4 may relate to an amount and/or quality of a substance 22 that is transportable in the transport system 21.

The node 1 can further comprise a receiver device 5, which is configured to receive a blockchain 6.

The node 1 may further comprise a generation device 7, which is configured to generate a data block 8 for the blockchain 6 on the basis of the measurement data 4 and the blockchain 6. Here, the data block 8 can comprise a checksum of the measurement data 11. Further, the data block 8 might not comprise the measurement data 4. Here, the generation device 7 may be connected to a status querying device 12 of the node 1 and output a status query 23 to the status querying device. The status querying device 12 can be configured to determine status data 13 which relate to an operational parameter of the measuring device 3, wherein the data block 8 generated by the generation device 7 is further based on the status data 13.

According to one embodiment of the node 1 according to FIG. 1, provision can further be made for the measuring device 3 to be configured for time-sequential capture of the measurement data 4 and for aggregation of the measurement data 4 in conjunction with the generation of the data block 8.

The node 1 may further comprise an output device 9, which is configured for separate output (i) of the data block 8 for validation by a further node 10a-10c and (ii) of the measurement data 4. Here, the further node 10a-10c can be embodied as a central node 14. Here, the output device 9 can be configured to transfer the data block 8 and the measurement data 4 to different further nodes 10a-10c within the network 2.

Further, the output device can be connected to a memory 15 arranged external to the node 1. Here, the output device can be configured to output the data block 8 to the memory 15 by means of a storage instruction 24 and to re-obtain the data block 8 stored in the memory 15 by way of a loading instruction 25a. Here, the memory 15 can be a local memory or cloud memory.

For cases in which the connection between the node 1 and the memory 15 may be temporarily interrupted or nonoperational, the node 1 may further comprise a buffer storing device 16, which is configured to temporarily store the data block 8 by way of a buffer store instruction 26 until the transfer by way of the output device 9 to the memory can be facilitated. The data block 8 buffer stored in the buffer 16 can be re-obtained by way of a loading instruction 25b.

According to a further embodiment that is not completely illustrated in FIG. 1, the receiver device 5 can be further configured to receive a further data block 29a-29c from a further node 10a-10c of the network 2 for the purposes of processing further measurement data 17a-17c of a further measuring device 18a-18c, wherein the node comprises a validation module 19 configured to validate the further data block 29a-29c on the basis of a comparison of a checksum 20a-20b of the further data block 29a-29c with the blockchain and to link the further data block 29a-29c with the blockchain 6 depending on a validation result.

FIG. 2 schematically illustrates a blockchain 6 according to one embodiment, for which a node 1 according to FIG. 1 can generate a data block 8. Here, the blockchain 6 may comprise a multiplicity of data blocks 29a-29c, which provide the linking means 27a-27c for linking the data blocks. Here, each of the saved further data blocks 29a-29c of the blockchain 6 can be indicative for further measurement data 17a-17c of further measuring devices 18 of further nodes 10a-10c of the network 2. By way of example, such indications can be saved in the transactions 28a-28c according to the blockchain 6 of FIG. 2. Equally, the checksum of the measurement data 11 can be saved in a transaction 28d of the data block 8 generated by means of the generation device 7. Each of the data blocks 29a-29c, 8 may further comprise a checksum 20a-20c, which is based on the data of the preceding data blocks 29a-29c.

FIG. 3 illustrates a network 2 with a multiplicity of nodes 1, 10a-10c for data exchange according to one embodiment. Here, each node 1 can receive measurement data 4, 17a-17c by means of a measuring device 3, 18a-18c and can create outputable data blocks 8, 29a-29c on the basis thereof. According to the embodiment illustrated in FIG. 3, all data blocks 8, 29a-29c generated in the network 2 are output to a central node 14 for validation for the blockchain 6. According to this embodiment, the central node 14 can be embodied as a central authority. However, reference should be made to the fact that decentralized validations of the generated data blocks 8, 29a-29c may also be provided according to other embodiments. By way of example, the data block 8 may also be validated by one of the further nodes 10a-10c according to other embodiments. This can equally also be provided for the data blocks 29a-29c.

FIG. 4 illustrates a flowchart of a method 10 for processing measurement data 4 according to one embodiment.

Here, at step 110, the method 100 may provide for capturing the measurement data 4, which map at least one physical variable.

Here, at step 120, the method 100 may provide for receiving the blockchain 6.

Here, at step 130, the method 100 may provide for generating a data block 8 for the blockchain 6 on the basis of the measurement data 4 and the blockchain 6.

Here, at step 140, the method may provide for separately outputting 140(i) the data block 8 for validation purposes and (ii) the measurement data 4.

Here, according to some embodiments, the method 100 can be carried out using a node 1 according to one of the embodiments presented herein.

FIG. 5 illustrates a flowchart of a method 200 for monitoring the processing of an industrial product by a multiplicity of nodes 1, 10a-10c of a network 2 and by means of a blockchain 6 according to one embodiment.

Here, at step 210, it is possible to carry out a capture of appropriate measurement data 4, 17a-17c, which map the processing of the industrial product to an appropriate measurement modality, at each of the nodes 1, 10a-10c.

At step 230, it is possible to carry out a generation 230 of a corresponding data block 8, 29a-29c for the blockchain 6 on the basis of the blockchain 6 and the corresponding measurement data 4, 17a-17c at each of the nodes 1, 10a-10c of the multiplicity of nodes 1, 10a-10c.

At step 250, it is possible to carry out a validation 250 of the data block 8, 29a-29c generated by a first node 1, 10a-10c of the multiplicity of nodes 1, 10a-10c by a second node 1, 10a-10c of the multiplicity of nodes 1, 10a-10c and/or by a central node 14 of the network 2.

According to some embodiments of the method 200, different nodes 1, 10a-10c of the multiplicity of nodes 1, 10a-10c can further map the processing of the industrial product by different measurement modalities and/or at different times and/or at different positions.

According to some further embodiments not illustrated herein, the checksums are embodied as hash values from which a hash value tree can be generated, the latter containing the information of all measurement values. Then, the hash value tree can be transferred to the central unit. According to further embodiments, the data transfers occurring within the node 1 are at least partly encrypted.

According to some further embodiments, it is further possible, in particular, to provide data in different ways, said data being stored in a transaction of a data block, for example. Instead of the data, e.g., user data such as measurement data or data/ownership relations in respect of assets, a transaction of a data block may only contain the checksum for these data, for example. Here, the corresponding checksum can be realized in different ways. By way of example, this can be an appropriate data block checksum of a data block (with the corresponding data) of another database or of the distributed database system, a transaction checksum of a data block with the corresponding data (of the distributed database system or another database) or a data checksum, which has been formed by way of the data. Additionally, the corresponding transaction may still comprise a reference or an indication to a storage location (e.g., an address of a file server and specifications where the corresponding data can be found on the file server; or an address of another distributed database comprising the data). Then, the corresponding data could be provided, for example also in a further transaction of a further data block of the distributed database system (e.g., if the corresponding data and the associated checksums are comprised in different data blocks). However, it is also conceivable, for example, for these data to be provided by way of a different communications channel (e.g., by way of another database and/or a cryptographically secured communications channel).

Additionally, for example in addition to the checksum, an additional data record (e.g., a reference or specification to a storage location) can be saved in the corresponding transactions, said additional data record, in particular, specifying a storage location from where the data can be recalled. This is particularly advantageous for the purposes of keeping a data size of the blockchain or of the distributed database system as small as possible.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A node of a network, comprising:
a measuring device configured to capture measurement data that map at least one physical variable,
a receiver device configured to receive a blockchain,
a generation device configured to generate a data block for the blockchain on the basis of the measurement data and the blockchain, and
an output device configured for separate output (i) of the data block for validation by a further node and (ii) of the measurement data.

2. The node as claimed in claim 1, wherein the data block comprises a checksum of the measurement data.

3. The node as claimed in claim 1, wherein the data block does not comprise the measurement data.

4. The node as claimed in claim 1, wherein the measuring device is configured for time-sequential capture of the measurement data and for aggregation of the measurement data in conjunction with the generation of the data block.

5. The node as claimed in claim 1, further comprising a status querying device configured to determine status data that relate to an operational parameter of the measuring device, wherein the data block generated by the generation device is further based on the status data.

6. The node as claimed in claim 1, wherein the output device is configured to output the data block to a central node of the network for validation purposes.

7. The node as claimed in claim 1, wherein the output device is configured to output the data block to a memory, wherein the memory is a local memory or cloud memory.

8. The node as claimed in claim 7, further comprising a buffer storing device, which is configured to temporarily store the data block until the transfer by the output device to the memory is facilitated.

9. The node as claimed in claim 1, wherein the blockchain comprises a multiplicity of saved further data blocks, wherein the saved further data blocks are indicative for further measurement data of further measuring devices of further nodes of the network.

10. The node as claimed in claim 1, wherein the output device is configured to transfer the data block and the measurement data to different further nodes within the network.

11. The node as claimed in claim 1, wherein the receiver device is further configured to receive a further data block from a further node of the network for the purposes of processing further measurement data of a further measuring device, wherein the node furthermore comprises:
a validation module configured to validate the further data block on the basis of a comparison of a checksum of the further data block with the blockchain and to link the further data block with the blockchain depending on a validation result.

12. The node as claimed in claim 1, wherein the measurement data relate to an amount and/or a quality of a substance that is transportable in a transport system.

13. A method for processing measurement data, including:
capturing the measurement data, which map at least one physical variable,
receiving a blockchain,
generating a data block for the blockchain on the basis of the measurement data and the blockchain, and
separately outputting the data block for validation purposes and the measurement data.

14. The method as claimed in claim 13, which is carried out on a node as claimed in claim 2.

15. A method for monitoring the processing of an industrial product by a multiplicity of nodes of a network and by means of a blockchain, said method including:
at each of the nodes of the multiplicity of nodes: capturing appropriate measurement data, which map the processing of the industrial product to an appropriate measurement modality,
at each of the nodes of the multiplicity of nodes: generating a corresponding data block for the blockchain on the basis of the blockchain and the corresponding measurement data,
validating the data block generated by a first node of the multiplicity of nodes by a second node of the multiplicity of nodes and/or by a central node of the network.

16. The method as claimed in claim 15, wherein different nodes of the multiplicity of nodes map the processing of the industrial product by different measurement modalities and/or at different times and/or at different positions.
